(19) United States
(12) Patent Application Publication
(10) Pub. No.: US 2025/0293242 A1
(43) Pub. Date: Sep. 18, 2025

(54) ANODE ACTIVE MATERIAL FOR LITHIUM SECONDARY BATTERY AND METHOD FOR PREPARING SAME

(71) Applicants: Hyundai Motor Company, Seoul (KR); Kia Corporation, Seoul (KR); Pukyong National University Industry-University Cooperation Foundation, Busan (KR)

(72) Inventors: Sang Hun Lee, Anyang (KR); Sung Ho Ban, Hwaseong (KR); Chang Hoon Song, Seoul (KR); Tae Ho Park, Hwaseong (KR); Eung Ju Lee, Daejeon (KR); Ki Kang Lee, Hwaseong (KR); Seung Min Oh, Incheon (KR); Seung Tae Kim, Yongin (KR); Seongsu Park, Changwon (KR); MinHong Choi, Busan (KR); Minseong Ko, Busan (KR); Sujong Chae, Busan (KR)

(21) Appl. No.: 18/825,213

(22) Filed: Sep. 5, 2024

(30) Foreign Application Priority Data
Mar. 13, 2024 (KR) 10-2024-0035244

(51) Int. Cl. H01M 4/36; H01M 4/02; H01M 4/38; H01M 4/587

(52) U.S. Cl. CPC H01M 4/366; H01M 4/386; H01M 4/587; H01M 2004/021; H01M 2004/027

(57) ABSTRACT

Disclosed is an anode active material for a lithium secondary battery, capable of attaining excellent charge capacity and electrical conductivity, by selectively filling a space of a porous particle with a diameter no larger than a specific size that cannot accommodate the volume change of silicon and coating a primary carbon coating layer, a silicon coating layer, and a secondary carbon coating layer in a space of the porous particle with a diameter no smaller than a specific size that can accommodate the volume change of silicon.

### CROSS-REFERENCE TO RELATED APPLICATION(S)

The present application claims under 35 U.S.C. § 119(a) the benefit of Korean Patent Application No. 10-2024-0035244, filed on Mar. 13, 2024, the entire contents of which is incorporated herein for all purposes by this reference.

### BACKGROUND

### Technical Field

The present disclosure relates to an anode active material for a lithium secondary battery, capable of attaining excellent charge capacity and electrical conductivity. This is accomplished by selectively filling a space of a porous particle with a cross-sectional dimension (e.g. diameter) no larger than a specific size, which cannot accommodate the volume change of silicon and by coating a primary carbon coating layer, a silicon coating layer, and a secondary carbon coating layer in a space of the porous particle with a cross-sectional dimension (e.g. diameter) no smaller than a specific size, which can accommodate the volume change of silicon.

### Background

With the recent significant increase in demand for electric vehicles as a solution to environmental problems, there has been an explosive increase in demand for high-energy density lithium secondary batteries, which are associated with the improvement in electric vehicle performance. Lithium secondary batteries function through the interactions of various components, with graphite primarily used as the anode active material. Of those, graphite is mainly used as an anode active material. However, graphite has an actual capacity (360 mAh/g) almost close to theoretical capacity (372 mAh/g, LiC₆), and thus there is a need for the introduction of a cathode active material having a higher theoretical capacity than graphite to increase the energy of the batteries.

However, silicon undergoes a volume expansion of three times or more due to changes in the crystal structure when alloyed with lithium, and a contraction of the previously expanded volume during de-alloying of lithium. Such volume expansion and contraction occurring repeatedly in the battery cycle causes the pulverization of an active material and the separation thereof from an electrode. Moreover, silicon alone is difficult to apply in batteries due to its lower electrical conductivity compared with graphite.

Various measures have been proposed to address the volume expansion issues among various problems of silicon anode materials. However, these measures are not suitable for use alone, as they still exhibit high volume expansion rates and low electrical conductivity when applied to commercial batteries. Moreover, these measures are accompanied by cost issues.

The information disclosed in this Background of the present disclosure section is only for enhancement of understanding of the general background of the present disclosure may not be taken as an acknowledgement or any form of suggestion that this information forms the related art already known to a person skilled in the art.

### SUMMARY

An embodiment of the present disclosure is to provide an anode active material for a lithium secondary battery and a method for preparing the same, wherein the anode active material is capable of attaining excellent charge capacity and electrical conductivity by selectively filling a space of a porous particle with a cross-sectional dimension (e.g. diameter) no larger than a specific size that cannot accommodate the volume change of silicon and coating a primary carbon coating layer, a silicon coating layer, and a secondary carbon coating layer in a space of the porous particle with a cross-sectional dimension (e.g. diameter) no smaller than a specific size that can accommodate the volume change of silicon.

The technical subjects pursued in the present disclosure may not be limited to the above-mentioned technical subjects, and other technical subjects which are not mentioned may be clearly understood, through the following descriptions, by those skilled in the art to which the present disclosure pertains.

In accordance with an embodiment of the present disclosure, there is provided an anode active material for a lithium secondary battery, including: a particle containing graphite and including a first space and a second space with a larger cross-sectional dimension (e.g. diameter) than the first space; a primary coating layer filling the first space and coated on the inner surface of the second space in the particle; and a silicon coating layer coated on the inner surface of the primary carbon coating layer of the second space.

The anode active material may further include a secondary carbon coating layer coated on the inner surface of the silicon coating layer of the second space.

In one aspect, the diameter of the first space suitably may be about 30 nm or smaller (excluding 0 nm).

Suitably, the cross-sectional dimensional dimension (e.g. diameter) of the second space is at least about 1, 2, 3, 4, 5, 6, 7, 8, 9 or 10 nm greater than the cross-sectional dimensional dimension (e.g. diameter) of the first space.

In one aspect, the BET surface area of the particle in a state in which the primary carbon coating layer is coated may be about 25% to 75% of the BET surface area of the particle before the primary carbon coating layer is coated.

In one aspect, the space fraction of the particle in a state in which the primary coating layer is coated may be about 50% to 80% of the space fraction of the particle before the primary carbon coating layer is coated, the space fraction being defined as the volume of the first space divided by the volume of the second space.

In one aspect, in the anode active material, based on a total volume of 100 vol % obtained by adding the volumes of the first space and the second space of the particle in a state in which the primary carbon coating layer is coated, the volume of the first space may be about 4 vol % or less.

In one aspect, the particle may have an average particle diameter (D₅₀) of 7-18 μm.

In one aspect, the total volume of all spaces including the first space and the second space of the particle may be about 0.01 to 0.05 cm³/g.

In one aspect, the weight of the primary carbon coating layer may be about 3 to 10 wt % based on a total of 100 wt % of the anode active material.

In one aspect, in the anode active material, the weight of the silicon coating layer is about 7.5-13.5 wt % based on a total of 100 wt % of the anode active material.

In one aspect, the weight of the secondary carbon coating layer is about 2-8 wt % based on a total of 100 wt % of the anode active material.

In accordance with another embodiment of the present disclosure, there is provided an anode active material for a lithium secondary battery, which is an anode active material containing graphite, wherein the anode active material includes an accommodation space, a primary carbon coating layer being coated on the inner surface of the accommodation space, and a silicon coating layer being coated on the inner surface of the primary carbon coating layer.

In one aspect, the accommodation space may have a cross-sectional dimension (e.g. diameter) of about 30 nm or larger.

In one aspect the carbon particle may have a cross-sectional dimension (e.g. diameter) of about 30 nm or smaller (but will be a positive or non-zero value).

In accordance with still another embodiment of the present disclosure, there is provided a method for preparing an anode active material for a lithium secondary battery, the method including: preparing a particle containing graphite and including a first space and a second space with a larger diameter than the first space; forming a primary carbon coating layer, which is filled inside the first space of the particle and coated on the inner surface of the second space of the particle; and coating a silicon coating layer on the primary carbon coating layer of the second space.

The method may further include, after the coating of the silicon coating layer, coating a secondary carbon coating layer on the silicon coating layer.

In the coating of the primary carbon coating layer, a sol-gel method is performed using a carbon material.

In the coating of the silicon coating layer, chemical vapor deposition may be performed using a silane-based gas.

In the coating of the secondary carbon coating layer, chemical vapor deposition may be performed using at least one material selected from a carbonization gas such as for example C₂H₄, CH₄ and mixtures thereof.

In accordance with still another embodiment of the present disclosure, there is provided an electrode for a lithium secondary battery, including the anode active material for a lithium secondary battery of the present disclosure.

In accordance with still another embodiment of the present disclosure, there is provided a lithium secondary battery including the anode active material for a lithium secondary battery of the present disclosure.

According to the present disclosure, an anode active material for a lithium secondary battery and a method for preparing the same can be provided wherein the anode active material is capable of attaining excellent charge capacity and electrical conductivity by selectively filling a space of a particle with a cross-sectional dimension (e.g. diameter) no larger than a specific size that cannot accommodate the volume change of silicon and coating a primary carbon coating layer, a silicon coating layer, and a secondary carbon coating layer in a space of the particle with a cross-sectional dimension (e.g. diameter) no smaller than a specific size that can accommodate the volume change of silicon.

In additional aspects, vehicles are provided that comprise a battery as disclosed herein, including a lithium secondary battery as disclosed herein.

Advantageous effects obtainable from the present disclosure may not be limited to the above-mentioned effects, and other effects which are not mentioned may be clearly understood, through the following descriptions, by those skilled in the art to which the present disclosure pertains.

### BRIEF DESCRIPTION OF THE DRAWINGS

The above and other embodiments, features and advantages of the present disclosure will be more apparent from the following detailed description taken in conjunction with the accompanying drawings.

FIG. 1 shows an anode active material for a lithium secondary battery according to an embodiment of the present disclosure.

FIG. 2 shows a method for preparing an anode active material for a lithium secondary battery according to an embodiment of the present disclosure.

FIG. 3 is a graph depicting cumulative space volume depending on space diameter in Examples 1 and 2 and Comparative Examples 1 and 2.

FIG. 4 is a graph depicting incremental space volume according to space diameter in Examples 1 and 2 and Comparative Examples 1 and 2.

FIG. 5 is a graph depicting an enlarged view of a part corresponding to a space diameter of 30 nm or smaller in FIG. 4

FIG. 6 shows an SEM cross-sectional image of an electrode using Comparative Example 1.

FIG. 7 shows an SEM cross-sectional image of an electrode using Example 1.

FIG. 8 is a graph comparing electrochemical performance for Examples 1 and 2 and Comparative Example 1.

FIG. 9 is a graph comparing discharge capacity depending on the number of charge and discharge cycles for Examples 1 and 2 and Comparative Example 1.

FIG. 10 is a graph comparing coulombic efficiency (CE) depending on the number of charge and discharge cycles for Examples 1 and 2 and Comparative Example 1.

### DETAILED DESCRIPTION OF THE EXEMPLARY EMBODIMENTS

Various changes and modifications may be made to the present disclosure, and the present disclosure may various embodiments, but particular embodiments illustrated in the drawings will be described in detail. However, it should be appreciated that this is not intended to limit the present disclosure to particular embodiments, and the present disclosure includes all various changes, equivalents, or alternatives falling within the sprit and scope of the present disclosure.

The terms used in the present disclosure are merely used to describe specific embodiments, and are not intended to limit the present disclosure. A singular expression may include a plural expression unless they are definitely different in a context. As used herein, the expression “include” or “have” is intended to specify the existence of mentioned features, numbers, steps, operations, elements, components, or combinations thereof, and should be construed as not precluding the possible existence or addition of one or more other features, numbers, steps, operations, elements, components, or combinations thereof.

Herein, it should be interpreted that a numerical value range of “X to Y” includes all numbers between X and Y. For example, it should be interpreted that a range of 1 to 10 includes not only 1 and 10 but also all the numbers in between, that is, integers and prime numbers.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless defined otherwise, all terms used herein, including technical and scientific terms, have the same meaning as those commonly understood by a person skilled in the art to which the disclosure pertains. Such terms as those defined in a generally used dictionary should be interpreted to have the meanings equal to the contextual meanings in the relevant field of art, and are not interpreted to have ideal or excessively formal meanings unless clearly defined in the present disclosure.

Herein, the specific surface area may be measured by a Brunauer-Emmett-Teller (BET) method. For example, a 6-point BET method may be employed, using a nitrogen gas adsorption flow technique with a porosimetry analyzer (BELSORP-mini II by Bell Japan Inc.). In addition to the above device, any device that is used in the art may be appropriately employed. Particularly, the specific surface area means the surface area per unit mass or unit volume.

Herein, The term ‘space’ may denote a pore or cavity or similar structure formed on the surface or within the structure of porous particles or graphite.

Herein, the diameter of a space may be measured by the Barrett-Joyer-Halenda (BJH) calculation equation through the nitrogen adsorption method. Specifically, the measurement is made using BEL Japan's BELSORP-mini II model. In addition to the above device, any device used in the art may be appropriately employed.

The “thickness” may be measured by imaging the surface or cross-section of a cathode active material using, for example, a microscope such as a scanning electron microscope. However, this is merely for illustration and may be measured through various other methods.

The sol-gel method or sol-gel process involves forming a selected precursor into a sol of stable colloidal particles (in a state in which very small particles are dispersed in a solvent). This sol is then transformed into a gel (in a state of having a porous structure where solid particles are partially filled with a solvent) through the gelling process to provide an inorganic material. The obtained colloidal particles can be precipitated to create desired forms, such as a single crystal, a fiber, a thin film, and a single-sized powder. Specifically, the sol-gel method or process may include: a precursor solution preparation step of dissolving a metal organic compound or an inorganic salt in a solvent to prepare a precursor solution; an aggregation and sol formation step of allowing particles to aggregate together to form a sol; a gel formation step of proceeding aggregation in a sol state to form a gel state; a drying step of drying the gel to remove the solvent and obtain a porous solid; and a heat treatment step of converting the dried gel into a nanomaterial with a necessary crystal structure and properties, such as a ceramic, glass, or a metal oxide. However, these steps are merely for examples, and additional steps may be performed or some steps may be omitted.

As for chemical vapor deposition (CVD), molecules or ions are transported by a fluid, such as gas, to form a solid thin film layer on the surface of a certain object.

The present disclosure is directed to an anode active material for a lithium secondary battery that can achieve excellent charge capacity and electrical conductivity. This is accomplished by selectively filling the space of a porous particle with a diameter no larger than a specific size that cannot accommodate the volume change of silicon and coating a primary carbon coating layer, a silicon coating layer, and a secondary carbon coating layer in a space with a diameter no smaller than a specific size that can accommodate the volume change of silicon.

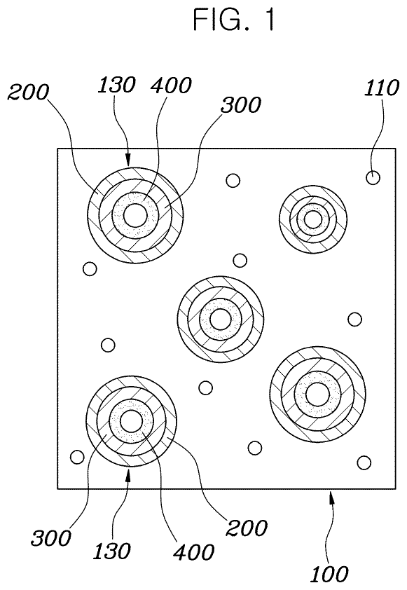

FIG. 1 shows an anode active material for a lithium secondary battery according to an embodiment of the present disclosure. An anode active material for a lithium secondary battery of the present disclosure will be described with reference to the drawing.

An anode active material for a lithium secondary battery according to an embodiment of the present disclosure may include: a porous particle 100 containing graphite and including a first space 110 and a second space 130 with a larger diameter than the first space; a primary coating layer 200 filled inside the first space 110 of the porous particle 100 and coated on the inner surface of the second space 130; a silicon coating layer 300 coated on the primary carbon coating layer 200 of the second space 130; and a secondary coating layer 400 coated on the silicon coating layer 300.

The anode active material for a lithium secondary battery of the present disclosure may include the porous particle 100 containing graphite.

The first space 110 included in the porous particle 100 may be filled with the primary carbon coating layer, and the inner surface of the second space 130 may be coated with the primary carbon coating layer 200, and the silicon coating layer 300 may be formed on the inner surface of the primary carbon coating layer 200.

The secondary carbon coating layer 400 with high conductivity may be coated on the inner surface of the silicon coating layer 300 of the second space 130.

Particularly, the porous particle 100 may have spaces with various diameters inside and outside, and the first space 110 and the second space 130 may be included therein.

Particularly, the graphite contained in the porous particle 100 may be spherical, amorphous, or natural graphite that has not undergone any separate process.

The average particle diameter (D₅₀) of the porous particle 100 may be 7-18 μm.

The second space 130 may have a diameter no smaller than a specific size that can accommodate the volume expansion of a silicon anode material during charging and discharging, and the diameter of the first space 110 may be smaller than the specific size.

For example, the diameter of the first space 110 may be 30 nm or smaller (excluding 0 nm), and the diameter of the second space 130 may be 30 nm or larger.

The porous particle, before the coating of the first carbon coating layer, may have a sum of the volumes per weight of the first and second spaces ranging of 0.01 to 0.05 cm³/g.

The first carbon coating layer 200 may be filled inside the first space and coated on the inner surface of the second space.

By a sol-gel method, the first carbon coating layer 200 may be filled inside the first space and coated on the inner surface of the second space.

Additionally, by using at least one material selected from a carbon material group including pitch, PVP, citric acid, and a mixture thereof, the primary carbon coating layer 200 may be filled inside the first space and coated on the inner surface of the second space.

The weight of the primary carbon coating layer may range from 1 to 10 wt %, preferably 3 to 10 wt %, based on a total of 100 wt % of the anode active material.

As can be confirmed in experimental examples to be described later, if the weight of the primary carbon coating layer falls below the corresponding range, the space having a diameter no larger than a specific size that cannot accommodate the volume change of silicon of the porous particle cannot be effectively filled. The reason may be that if the weight of the primary carbon coating layer exceeds the corresponding range, even the space having a diameter no smaller than a specific size that can accommodate the volume change of silicon in the porous particle may be filled.

The silicon coating layer 300 may serve as an anode material that stores and releases lithium through an alloying reaction during charging and discharging of the lithium secondary battery.

The silicon coating layer 300 may be coated on the inner surface of the first carbon coating layer 200 of the second space 130.

The silicon coating layer 300 may be coated by chemical vapor deposition (CVD) and may be coated using a gas containing a material selected from a silane-based gas group including SiH₄(g).

The weight of the silicon coating layer 300 may range from 7.5 to 13.5 wt % based on a total of 100 wt % of the anode active material.

The reason may be that if the weight of the silicon coating layer 300 falls below the corresponding range, the silicon coating layer 300 may not be sufficiently formed. The reason may be that if the weight of the silicon coating layer 300 exceeds the corresponding range, the silicon coating layer 300 may be excessively formed and thus the second space 130 cannot accommodate the volume change during charging and discharging, causing the destruction and detachment of the anode active material for a lithium secondary battery of the present disclosure.

Meanwhile, the secondary carbon coating layer 400 may be coated on the inner surface of the silicon coating layer 300.

The secondary carbon coating layer, which is an amorphous carbon coating layer, has high conductivity and thus can enhance the electrical conductivity of the anode electrode active material.

The secondary carbon coating layer 400 may be coated by chemical vapor deposition (CVD) and may be coated using a gas containing a material selected from a carbonization gas material group including C₂H₄, CH₄, and a mixture thereof.

The weight of the secondary carbon coating layer may range from 2 to 8 wt % based on a total of 100 wt % of the anode active material.

If the weight of the secondary carbon coating layer 400 falls below the corresponding range, it may not be sufficiently formed, resulting in an insignificant synergistic effect in electrical conductivity. Conversely, if the weight of the secondary carbon coating layer 400 exceeds the corresponding range, it may be excessively formed to prevent the entrance of metal ions including lithium into the silicon coating layer 300, causing a reduction in electrochemical performance.

In the porous particle 100 of the anode active material for a lithium secondary battery of the present disclosure, the BET surface area in a state in which the primary carbon coating layer 200 is coated may be 25% to 75% of the BET surface area before the primary carbon coating layer is coated.

In the porous particle 100, the space fraction in a state in which the primary coating layer 200 is coated is 50% to 80% of the space fraction before the primary carbon coating layer 200 is coated, wherein the space fraction may be defined as the volume of the first space divided by the volume of the second space.

In the porous particle in a state in which the primary coating layer 200 is coated, the volume of the first space may be 4 vol % or less based on a total volume of 100 vol % obtained by adding the volumes of the first and second spaces.

The total volume of all spaces including the first space 110 and the second space 130 of the porous particle 100 before the coating of the first carbon coating layer 200 may be 0.01-0.05 cm³/g.

An anode active material for a lithium secondary battery according to an embodiment of the present disclosure is described from a different perspective.

An anode active material for a lithium secondary battery according to an embodiment of the present disclosure includes graphite, including: a carbon particle with a diameter no larger than a specific size; and an accommodation space with a specific diameter or larger. A primary carbon coating layer is coated on the inner surface of the accommodation space, a silicon coating layer is coated on the inner surface of the primary carbon coating layer, and a secondary carbon coating layer is coated on the inner surface of the silicon coating layer of the accommodation space.

Meanwhile, the graphite may correspond to the above-described porous particle 100, the carbon particle may correspond to the primary carbon coating layer filled inside the above-described first space 110, the accommodation space may correspond to the above-described second space 130. The silicon coating layer and the secondary carbon coating layer may correspond to the above-described silicon coating layer 300 and secondary carbon coating layer 400, respectively.

Particularly, the graphite may be spherical in the form of a ball, or may be amorphous, or may be natural graphite that has not undergone a separate process. The average particle diameter (D₅₀) of the graphite may be 7-18 μm.

The carbon particle may be formed by coating the primary carbon coating layer in a space with a smaller diameter than the accommodation space included in the graphite.

The carbon particle may have a diameter smaller than the accommodation space, and for example, the carbon particle may have a diameter smaller than 30 nm.

The carbon particle may be formed using a sol-gel method and may be formed using at least one material selected from a carbon material group including pitch, PVP, citric acid, and a mixture thereof.

The accommodation space may have a diameter no smaller than a specific size, sufficient to accommodate the volume change of silicon present in the graphite during charging and discharging.

For example, the diameter of the accommodation space may be 30 nm or larger.

Meanwhile, the primary carbon coating layer may be coated on the inner surface of the accommodation space.

The primary carbon coating layer may be coated by a sol-gel method and may be coated using at least one material selected from a carbon material group including pitch, PVP, citric acid, and a mixture thereof.

The weight of the primary carbon coating layer may range from 1 to 10 wt %, preferably 3 to 10 wt %, based on a total of 100 wt %, of the anode active material.

Meanwhile, the silicon coating layer may be coated on the inner surface of the primary carbon coating layer within the accommodation space. The silicon coating layer serves as an anode material that stores and releases lithium through an alloying reaction during charging and discharging of the lithium secondary battery.

The silicon coating layer may be coated by chemical vapor deposition (CVD) and may be coated using a gas containing a material selected from a silane-based gas group including SiH₄(g).

The weight of the silicon coating layer 300 may range from 7.5 to 13.5 wt % based on a total of 100 wt % of the anode active material.

Meanwhile, the secondary carbon coating layer may be coated on the inner surface of the silicon coating layer of the accommodation space.

The secondary carbon coating layer, which is an amorphous carbon coating layer, has high conductivity and thus can enhance the electrical conductivity of the anode electrode active material.

The secondary carbon coating layer may be coated by chemical vapor deposition (CVD) and may be coated using a gas containing at least one material selected from a carbonization gas material group including C₂H₄, CH₄, and a mixture thereof.

The weight of the secondary carbon coating layer may range from 2 to 8 wt % based on a total of 100 wt % of the anode active material.

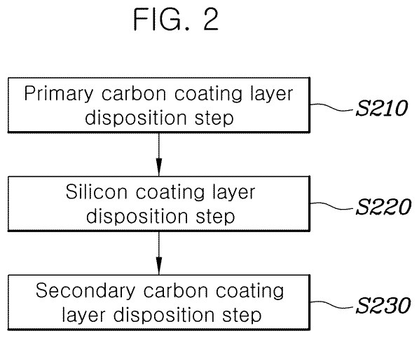

FIG. 2 shows a flow chart of a method for preparing an anode active material for a lithium secondary battery according to an embodiment of the present disclosure. A method for preparing an anode active material for a lithium secondary battery of the present disclosure will be described with reference to the drawing.

In the method for preparing an anode active material for a lithium secondary battery of the present disclosure, a step of forming a primary carbon coating layer with respect to a porous particle containing graphite and including a first space and a second space with a larger diameter than the first space, wherein the primary carbon coating layer is filled inside the first space of the porous particle and coated on the inner surface of the second space of the porous particle, is performed (S210).

Particularly, the primary carbon coating layer may be coated in the first space and second space of the porous particle containing graphite by using a sol-gel method.

Particularly, a solvent used in the sol-gel method may be an organic solvent selected from an organic solvent group including tetrahydrofuran (THF).

Pitch, a precursor of the porous particle and primary carbon coating layer, may be added to the corresponding organic solvent.

Meanwhile, a material used for forming the primary carbon coating layer may be at least one material selected from a carbon material group including pitch, PVP, citric acid, and a mixture thereof.

For example, the pitch added may have a residual carbon rate of 60% and a softening point of 260° C.

Particularly, the pitch, which is a precursor of the primary carbon coating layer, may be added such that the weight of the primary carbon coating layer range from 1 to 10 wt %, preferably 3 to 10 wt %, based on a total of 100 wt % of the anode active material.

Especially, the diameter of the space filled with the primary carbon coating layer may be controlled by adjusting the weight of the primary carbon coating layer compared with the anode active material.

For example, an increase in weight of the primary carbon coating layer compared with the anode active material may increase the maximum diameter of the space filled with the primary carbon coating layer, and a reduction in weight of the primary carbon coating layer compared with the anode active material may decrease the maximum diameter of the space filled with the primary carbon coating layer.

Specifically, if the weight of the primary carbon coating layer is 10 wt % or more based on a total of 100 wt % of the anode active material, the space having a diameter larger than 30 nm may be filled with the primary carbon coating layer, and if the weight of the primary carbon coating layer is 3 wt % or less based on a total of 100 wt % of the anode active material, the space having a diameter smaller than 30 nm may be filled with the primary coating layer.

After coating the space of the porous particle with at least one material selected from a carbon material group, including pitch, PVP, citric acid, and a mixture thereof, which is a precursor of the primary carbon coating layer, a pretreatment process may be carried out.

The pretreatment process may be carried out in an inert atmosphere of Ar.

The pretreatment process may be composed of a softening heat treatment process and a carbonization heat treatment process.

Specifically, first, the softening heat treatment process may be carried out by heating for 2 hours at 260° C., which is the softening point of the precursor pitch.

The pitch is softened through the corresponding process, so that the pitch is uniformly distributed inside and outside the porous particle, thereby filling the first space more well.

Then, the carbonization heat treatment process may be carried out by heating for 2 hours at 920° C., which is the combustion temperature of the precursor. The corresponding procedure can lead to an improvement in the crystallinity of the pitch distributed inside and outside the porous particle, as well as the removal of impurities.

This step enables the formation of the primary carbon coating layer, which is selectively filled inside the first space having a diameter no larger than a specific size that cannot accommodate the volume change of silicon of the porous particle, and coated on the inner surface of the second space having a diameter no smaller than a specific size that can accommodate the volume change of silicon of the porous particle.

Then, a step of coating a silicon coating layer on the inner surface of the first carbon coating layer of the second space may be performed (S220).

In the step of coating the primary carbon coating layer, the first space may have already been filled with the primary carbon coating layer. Thus, the silicon coating layer may be selectively formed only on the primary carbon coating layer formed in the second space.

The silicon coating layer may be coated on the primary carbon coating layer of the second space by using chemical vapor deposition (CVD).

Particularly, the gas used to coat the silicon coating layer may be a gas containing a material selected from a silane-based gas group including SiH₄(g).

Specifically, in order to coat the silicon coating layer, the corresponding silane-based gas may be introduced at a flow rate of 100 sccm for 62.2 minutes at a decomposition temperature of 475° C.

Particularly, rotation as well as heat treatment may be performed in a rotary furnace with a rotation speed of one rotation per minute in order to reduce the aggregation between powders during synthesis through chemical vapor deposition.

The silicon coating layer formed through such a procedure may be formed in a quasi-crystalline phase, and the weight of the silicon coating layer may range from 7.5 to 13.5 wt % based on a total of 100 wt % of the anode active material.

Then, a step of coating a secondary carbon coating layer on the silicon coating layer of the second space may be performed (S230).

An amorphous carbon coating layer having high conductivity may be formed on the silicon coating layer formed in the second space of the porous particle.

Particularly, the secondary carbon coating layer may be applied to the silicon coating layer in the second space by using chemical vapor deposition.

First, the temperature may be raised to a temperature, at which the carbonization gas can be decomposed, in an Ar atmosphere.

Specifically, the temperature may be 930° C. or higher, and thereafter, a carbonization gas is injected at a flow rate of 500 sccm for 10 minutes to allow the secondary carbon coating layer to be deposited on the silicon coating layer, and replaced with the Ar atmosphere, followed by cooling, thereby coating the secondary carbon coating layer on the silicon coating layer of the second space.

Particularly, the carbon gas used to coat the secondary carbon coating layer may be a gas containing a material selected from a carbonization gas material group including C₂H₄, CH₄, or a mixture thereof.

The secondary carbon coating layer formed through this procedure has high conductivity and may be an amorphous carbon coating layer.

The weight of the secondary carbon coating layer may range from 2 to 8 wt % based on a total of 100 wt % of the anode active material.

Through this method, an anode active material for a lithium secondary battery can be prepared, which can accommodate the sharp volume changes of a silicon anode material during charging and discharging, while ensuring high charge capacity of the silicon anode material.

Another embodiment of the present disclosure can provide an anode containing the anode active material for a lithium secondary battery of the present disclosure.

Still another embodiment of the present disclosure can provide a lithium secondary battery including: an anode containing the anode active material for a lithium secondary battery of the present disclosure; a cathode containing a cathode active material; and an electrolyte.

Specifically, the lithium secondary battery of the present disclosure may be manufactured by injecting a non-aqueous electrolyte of the present disclosure into an electrode structure composed of a cathode, an anode, and a separator interposed between the cathode and the anode. Particularly, the anode, cathode, and separator constituting the electrode structure may be those commonly used in the manufacturing of lithium secondary batteries. Hereinafter, these elements will be described.

### <Anode>

An anode active material may be formed using a material that can provoke the de-intercalation or conversion reaction of lithium ions.

The anode material may be obtained by mixing an anode active material, a conductive material, and a binder.

The anode material may be applied onto an anode current collector to form an anode. The anode current collector may be a conductor. To apply the anode material onto the anode current collector, press molding may be used. Alternatively, a paste is made using an organic solvent and the like and then the paste is applied onto a current collector, where it is fixed through pressing.

### <Electrolyte>

The electrolyte may contain lithium. Alternatively, an electrolyte containing fluorine may be used. The electrolyte may be dissolved in an organic solvent and used as a non-aqueous electrolyte. Alternatively, a solid electrolyte may be used. In addition, the solid electrolyte may serve as a separator to be later described, and in such a case, a separator may not be needed.

### <Separator>

A separator may be disposed between the cathode and the anode. This separator may be made of materials having a form of a porous film, a nonwoven fabric, a fabric, or the like. It is preferable for the separator to be thinner, as long as the mechanical strength of the separator is maintained. A thinner separator increases the volume energy density of the battery and decreases internal resistance.

### <Manufacturing Method of Lithium Secondary Battery>

A lithium secondary battery may be manufactured by sequentially stacking the cathode, the separator, and the anode to form an electrode group, rolling the electrode group, if needed, holding the electrode group in a battery can, and impregnating the electrode group with the electrolyte. Unlike this, the secondary battery may be manufactured by stacking the cathode, the solid electrolyte, and the anode to form an electrode group, and rolling the electrode group, if needed, and holding the electrode group in a battery can.

Hereinafter, preferable examples will be set forth for better understanding of the present disclosure. However, the following experimental examples are provided to help in understanding the present disclosure, and the present disclosure is not limited to the following experimental examples.

### EXAMPLES AND COMPARATIVE EXAMPLES

### Example 1

A primary carbon coating layer was coated on 50 g of natural spheroidized graphite by using a sol-gel method, and then a silicon coating layer was formed by chemical vapor deposition at a flow rate of 100 sccm for 62.2 minutes in an Ar atmosphere chamber at 475° C., thereby preparing an anode active material. Particularly, the weight of the primary carbon coating layer was 3 wt % and the weight of the silicon coating layer was 10.5 wt % and the weight of the silicon coating layer was 5 wt % based on a total of 100 wt % of the anode active material.

### Example 2

An anode active material was prepared by the same method as in Example 1 except that the weight of the primary carbon coating layer was 10 wt % based on a total of 100 wt % of the anode active material.

### Comparative Example 1

An anode active material was prepared by the same method as in Example 1 except that the primary carbon coating layer was not coated (0 wt %) on the natural spheroidized graphite.

### Comparative Example 2

An anode active material was prepared by the same method as in Example 1 except that the weight of the primary carbon coating layer was 1 wt % based on a total of 100 wt % of the anode active material.

### Experimental Example

### (1) Electrode Manufacturing

A slurry was prepared by mixing the anode active material of the present disclosure, a conductive material, and a binder at a ratio of 96:1:3.

Particularly, super-P was used as the conductive material, and styrene butadiene rubber (SBR) and sodium carboxymethyl cellulose (CMC) mixed at a weight ratio of 1.5:1.5 were used as a binder.

The slurry was uniformly applied onto a copper foil and dried at 80° C. in an oven for about 1 hour, and then the resultant product was roll-pressed and further dried at 120° C. for in a vacuum oven for 6 hours and 30 minutes, thereby manufacturing an anode plate.

### (2) Half-Cell Manufacturing

The manufactured anode plate and lithium foil were used as a counter electrode.

A porous polyethylene film is used as a separator.

In addition, a liquid electrolyte in which 1.3 M LiPF₆, 10 wt % fluoro-ethylene carbonate (FEC), 0.2 wt % lithium tetrafluoroborate (LiBF₄), 0.5 wt % vinylene carbonate (VC), and 1 wt % propane sultone (PS) additives were dissolved in a solvent of ethylene carbonate (EC), ethyl methyl carbonate (EMC), and dimethyl carbonate (DMC) at a volume ratio of 3:5:2 was used to manufacture a CR2032 coin-type half-cell.

### (3) Space Analysis (BET and BJH)

Examples 1 and 2 and Comparative Examples 1 and 2 were analyzed through BET and BJH analysis for the BET surface area and the volume of spaces (first spaces) with a diameter of 30 nm or smaller and spaces (second spaces) with a diameter of 30 nm or larger.

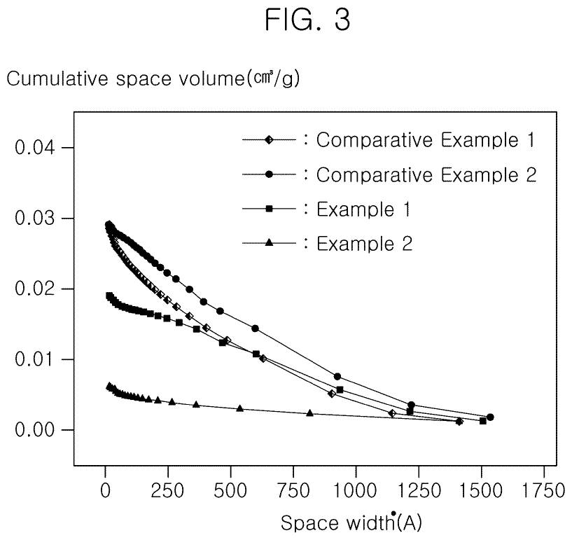

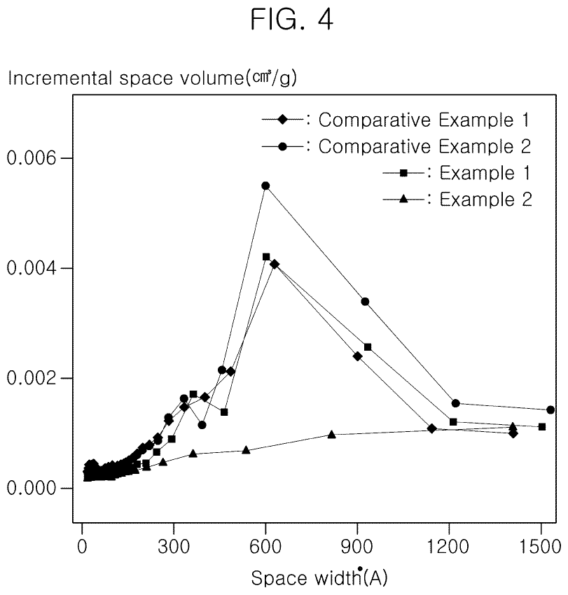

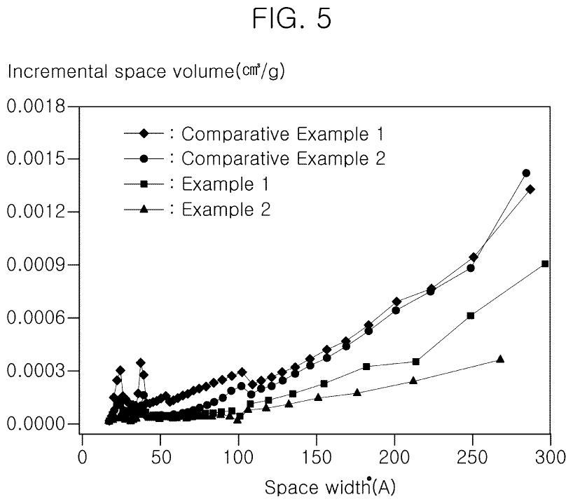

FIG. 3 is a graph depicting cumulative space volume depending on space diameter in Examples 1 and 2 and Comparative Examples 1 and 2; FIG. 4 is a graph depicting incremental space volume according to space diameter in Examples 1 and 2 and Comparative Examples 1 and 2; and FIG. 5 is a graph depicting an enlarged view of a part corresponding to a space diameter of 30 nm or smaller in FIG. 4

The experimental results are summarized in Table 1 below with reference to the drawings.

TABLE 1

| | | space | 30 nm ≤ | |
|---|---|---|---|---|
| | | volume < | space | BJH adsorption |
| | BET Surface | 30 nm | volume | space volume |
| | Area (m²/g) | (cm³/g) | (cm³/g) | (cm³/g) |
| Comparative | 7.8372 | 0.001445 | 0.026938 | 0.028383 |
| Example 1 | | | | |
| (0 wt %) | | | | |
| Comparative | 5.6606 | 0.000754 | 0.028224 | 0.028978 |
| Example 2 | | | | |
| (1 wt %) | | | | |
| Example 1 | 4.0761 | 0.000667 | 0.018335 | 0.019002 |
| (3 wt %) | | | | |
| Example | 1.4981 | 0.000287 | 0.005528 | 0.005815 |
| (10 wt %) | | | | |

Regarding the BET surface area, Comparative Example 1 without the first carbon coating layer showed the highest value, and Examples 1 and 2 and Comparative Example 2 showed a tendency of reduction in BET surface area with an increasing content of the primary carbon coating layer.

It could be therefore identified that the primary carbon coating layer filled spaces, and an increased content of the primary carbon coating layer resulted in more spaces being filled. This, in turn, reduced the BET surface area of the porous particle.

Regarding the volume of the spaces with a diameter of 30 nm or smaller, Comparative Example 1 without the primary carbon coating layer showed the highest value, and Examples 1 and 2 and Comparative Example 2 showed a tendency of reduction in volume of the spaces with a diameter of 30 nm or smaller with an increasing weight of the primary carbon coating layer.

Regarding the volume of the spaces with a diameter of 30 nm or larger, Comparative Example 1 without the primary carbon coating layer and Comparative Example 2 with a primary carbon coating layer content of 1 wt % showed similar values, and Examples 1 and 2 showed a tendency of reduction in volume of the spaces with a diameter of 30 nm or larger with an increasing weight of the primary carbon coating layer.

It could be therefore identified that an increasing weight of the primary carbon coating layer effectively filled the spaces of the porous particle. In addition, an increasing weight of the primary carbon coating layer resulted in a reduction in volume of the spaces with a diameter of 30 nm or smaller as well as a reduction in volume of the spaces with a diameter of 30 nm or larger. It could be therefore identified that the increase in weight of the primary carbon coating layer could fill the spaces with a diameter larger than 30 nm.

Regarding BJH adsorption space volume, comparative Example 1 without the primary carbon coating layer and Comparative Example 2 with a primary carbon coating layer content of 1 wt % showed similar values. In contrast, Examples 1 and 2 showed a tendency of reduction in BJH adsorption space volume as the weight of the primary carbon coating layer increased.

### (4) SEM Cross-Sectional Analysis

By utilizing an ion milling machine (Gatan 697 Ilion II), each of the electrodes employing the anode active materials of Example 1 and Comparative Example 1 was manufactured, subjected to charging and discharging, and cross-sectional samples of the corresponding electrodes was fabricated. SEM cross-sectional images therefor were taken and analyzed.

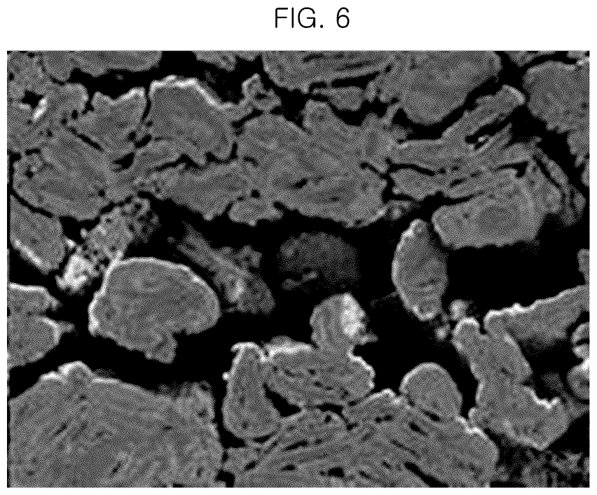

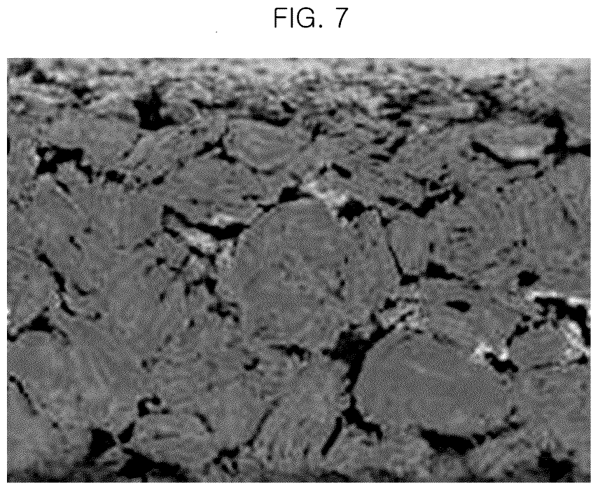

FIG. 6 shows an SEM cross-sectional image of an electrode using Comparative Example 1; and FIG. 7 shows an SEM cross-sectional image of an electrode using Example 1.

In FIG. 6, there were large black gaps between gray active material sites, that is, electrical short circuits between active material sites.

The reason may be that a silicon coating layer was formed in spaces with a diameter no larger than a specific size. which cannot accommodate the volume change of silicon during charging and discharging. This leads to electrical short circuits between active material sites resulting from the volume change of silicon during these cycles.

The gaps between gray active material sites shown in FIG. 7 were smaller than those in Comparative Example 1 in FIG. 6, indicating a low degree of electrical short circuit between active material sites.

The reason may be that a silicon coating layer was formed in spaces with a diameter no smaller than a specific size that can accommodate the volume change of silicon during charging and discharging, causing no electrical short circuits between active material sites resulting from the volume change of silicon during charging and discharging.

### (5) Evaluation of Electrochemical Properties

Example 1 and Comparative Example 1 were subjected to electrochemical analysis under the following conditions.
Cut off voltage (V): 0.005-1.5 V
Formation C-rate (C): 0.1 C lithiation, 0.1 C delithiation
Cycle C-rate (C): 0.5 C lithiation, 0.5° C. delithiation

The initial coulombic efficiency (ICE) was calculated using Equation 1 below, with a higher value indicating better initial reversibility.

The capacity retention rate was determined through Equation 2 below, with a higher value indicating better lifespan characteristics.

ICE=(initial discharge capacity/initial charging capacity) [Equation 1]

Capacity retention rate=(initial charging capacity/charging capacity after 50 charge/discharge cycles] [Equation 2]

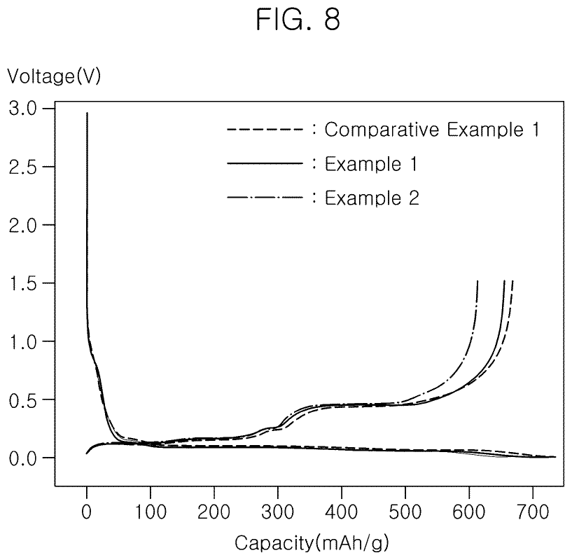

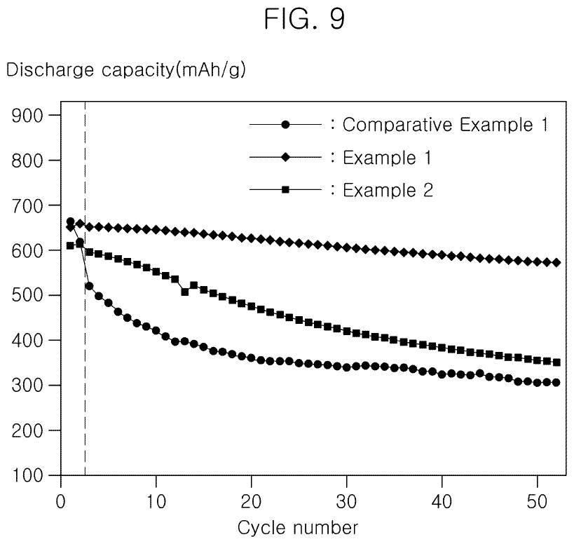

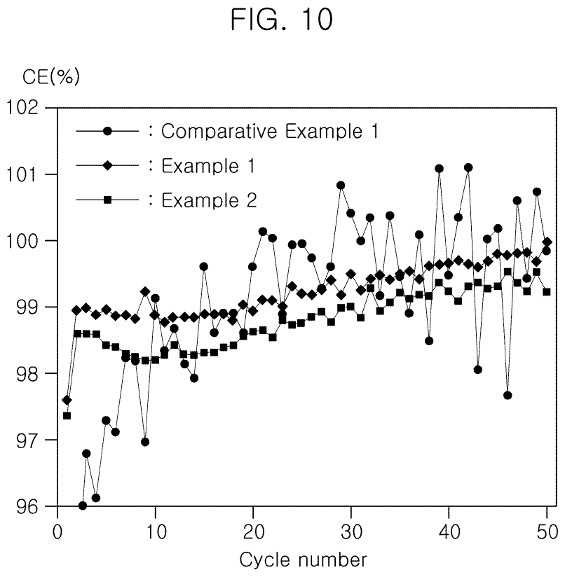

FIG. 8 is a graph comparing electrochemical performance for Examples 1 and 2 and Comparative Example 1; FIG. 9 is a graph comparing discharge capacity depending on the number of charge and discharge cycles for Examples 1 and 2 and Comparative Example 1; and FIG. 10 is a graph comparing coulombic efficiency (ICE) depending on the number of charge and discharge cycles for Examples 1 and 2 and Comparative Example 1. The results are summarized in Table 2.

TABLE 2

| | Charge | Discharge | | Capacity |
|---|---|---|---|---|
| | capacity | capacity | | retention |
| | (mAh/g) | (mAh/g) | ICE (%) | rate (%) |
| Comparative | 736.2 | 669.5 | 90.9 | 58.4 |
| Example 1 | | | | |
| (0 wt %) | | | | |
| Example 1 | 712.4 | 656.2 | 92.1 | 86.9 |
| (3 wt %) | | | | |
| Example 2 | 656.8 | 612.7 | 93.3 | 58.8 |
| (10 wt %) | | | | |

Regarding charge capacity and discharge capacity, Comparative Example 1 showed the highest value, Example 1 showed the second highest value, and Example 2 showed the lowest value.

Regarding ICE, Example 2 showed the highest value, Example 1 showed the second highest value, and Comparative Example 1 showed the lowest value.

Regarding the capacity retention rate, the anode active material of Example 1 showed the highest capacity retention rate even after 50 charge and discharge cycles.

The anode active material of Comparative Example 1 showed the lowest capacity retention rate after 50 charge and discharge cycles.

The reason may be that as for Examples 1 and 2, the primary carbon coating layer filled the first spaces with a diameter of 30 nm or smaller, which cannot accommodate the volume change of silicon. Additionally, both the primary carbon coating layer and the silicon coating layer were formed in the second spaces with a diameter of 30 nm or larger, which can accommodate the volume change of silicon. This effectively accommodates the volume change of silicon resulting from charging and discharging to prevent the detachment and destruction of the anode active material.

The reason may also be that as for Comparative Example 1, the primary carbon coating layer was not formed and thus failed to accommodate the volume change of silicon. This resulted in the detachment and destruction of the anode active material.

It can be therefore identified that the presence of the primary carbon coating layer has a positive effect on the lifespan characteristics of the battery.

The above detailed description should not be construed in a limitative sense, but should be considered in an illustrative sense in all embodiments. The scope of the present disclosure should not be determined by reasonable interpretation of the appended claims, and all changes and modifications within the equivalent scope of the present disclosure fall within the scope of the present disclosure. Furthermore, The term “and/or” may include a combination of a plurality of related listed items or any of a plurality of related listed items. For example, “A and/or B” includes all three cases such as “A”, “B”, and “A and B”. In the present specification, unless stated otherwise, a singular expression includes a plural expression unless the context clearly indicates otherwise. In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”. In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof. The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An anode active material for a lithium secondary battery, the anode active material comprising:
a particle comprising graphite and comprising a first space and a second space with a larger cross-sectional dimension than the first space;
a primary carbon coating layer in the first space and coated on an inner surface of the second space; and
a silicon coating layer coated on an inner surface of the primary carbon coating layer of the second space.

2. The anode active material of claim 1, further comprising a secondary carbon coating layer coated on an inner surface of the silicon coating layer of the second space.

3. The anode active material of claim 1, wherein a diameter of the first space is about 30 nm or smaller.

4. The anode active material of claim 1, wherein a BET surface area of the particle in a state in which the primary carbon coating layer is coated is about 25% to 75% of a BET surface area of the particle before the primary carbon coating layer is coated.

5. The anode active material of claim 1, wherein a space fraction of the particle in a state in which the primary coating layer is coated is about 50% to 80% of a space fraction of the particle before the primary carbon coating layer is coated, the space fraction being defined as a volume of the first space divided by a volume of the second space.

6. The anode active material of claim 1, wherein a volume of the first space is about 4 vol % or less, based on a total volume of 100 vol % obtained by adding volumes of the first space and the second space of the particle in a state in which the primary carbon coating layer is coated.

7. The anode active material of claim 1, wherein a weight of the primary carbon coating layer is about 3 to 10 wt %, based on a total of 100 wt % of the anode active material.

8. The anode active material of claim 1, wherein a weight of the silicon coating layer is about 7.5-13.5 wt %, based on a total of 100 wt % of the anode active material.

9. The anode active material of claim 2, wherein a weight of the secondary carbon coating layer is about 2-8 wt %, based on a total of 100 wt % of the anode active material.

10. An anode active material for a lithium secondary battery, the anode active material comprising:
a carbon particle comprising graphite and comprising an accommodation space,
a primary carbon coating layer coated on an inner surface of the accommodation space, and
a silicon coating layer coated on an inner surface of the primary carbon coating layer.

11. The anode active material of claim 10, wherein the accommodation space has a diameter of about 30 nm or larger.

12. The anode active material of claim 10, wherein the carbon particle has a diameter of about 30 nm or smaller.

13. The anode active material of claim 10, wherein a secondary carbon coating layer is coated on an inner surface of the silicon coating layer.

14. A method for preparing an anode active material for a lithium secondary battery, the method comprising:
providing a particle comprising graphite and comprising a first space and a second space with a larger cross-sectional dimension than the first space;
filling a primary carbon coating layer inside the first space of the particle;
coating the primary carbon coating layer on an inner surface of the second space of the particle; and
coating a silicon coating layer on an inner surface of the primary carbon coating layer of the second space.

15. The method of claim 14, further comprising, after the coating of the silicon coating layer, coating a secondary carbon coating layer on an inner surface of the silicon coating layer.

16. The method of claim 14, wherein a sol-gel method is performed using a carbon material to coat the primary carbon coating layer.

17. The method of claim 14, wherein chemical vapor deposition is performed using a silane-based gas to coat the silicone coating layer.

18. The method of claim 15, wherein chemical vapor deposition is performed using a carbonization gas to coat the secondary carbon coating layer.

19. An electrode for a lithium secondary battery, the electrode comprising the anode active material of claim 1.

20. A lithium secondary battery comprising the anode active material of claim 1.
